(19) United States
(12) Patent Application Publication
(10) Pub. No.: US 2026/0042350 A1
(43) Pub. Date: Feb. 12, 2026

(54) LAMINATED TRANSPARENT PLATE AND METHOD OF MANUFACTURING THE SAME

(71) Applicant: AGC Inc., Tokyo (JP)

(72) Inventors: Masahide KOGA, Tokyo (JP); Yukihiro TAO, Tokyo (JP); Taketsune MORI, Tokyo (JP)

(73) Assignee: AGC Inc., Tokyo (JP)

(21) Appl. No.: 19/362,595

(22) Filed: Oct. 20, 2025

Related U.S. Application Data
(63) Continuation of application No. PCT/JP2024/016779, filed on May 1, 2024.

(30) Foreign Application Priority Data
May 11, 2023 (JP) 2023-078321

(51) Int. Cl. B60K 35/28; B32B 5/02; B32B 17/06; B32B 17/10; G09G 3/32; H01Q 1/12; H01Q 1/38; H01Q 1/52

(52) U.S. Cl. CPC B60K 35/28; B32B 5/028; B32B 17/061; B32B 17/10541; H01Q 1/1271; H01Q 1/38; H01Q 1/526; B32B 2307/212; B32B 2307/412; B32B 2307/7376; B32B 2457/206; B32B 2605/00; B60K 2360/16; B60K 2360/785; G09G 3/32; G09G 2380/10

(57) ABSTRACT

Provided is a laminated transparent plate including: a pair of transparent plates; a display device that is sandwiched between the pair of transparent plates and includes a first substrate and a plurality of display elements formed on the first substrate; and a near-field wireless communication antenna that is sandwiched between the pair of transparent plates and includes a second substrate and a spiral coil formed on the second substrate. The display device and the near-field wireless communication antenna are disposed to overlap each other in plan view, and an electromagnetic shield member that includes a third substrate and a metal mesh film formed on the third substrate is provided between the display device and the near-field wireless communication antenna.

### INCORPORATION BY REFERENCE

This application is based upon and claims the benefit of priority from Japanese Patent Application No. 2023-078321 filed on May 11, 2023 and PCT application No. PCT/JP2024/016779 filed on May 1, 2024, the disclosure of which is incorporated herein in its entirety by reference.

### BACKGROUND

The present disclosure relates to a laminated transparent plate and a method of manufacturing the same, and for example, relates to a laminated transparent plate including a display device and a near-field wireless communication antenna between a pair of transparent plates, and a method of manufacturing the same.

As disclosed in Patent Literature 1, the inventors have developed a transparent display device using a fine light emitting diode (LED) element formed on a transparent substrate as a pixel. Such a transparent display device is provided on a transparent member such as a window or a partition of a vehicle or a building, for example, since a rear surface side (the side opposite to a visible side) can be visually recognized through the transparent display device.

Meanwhile, Patent Literature 2 discloses a laminated glass in which a display device and a near-field wireless communication (NFC) antenna are disposed close to each other between a pair of glass plates.

### Patent Literature 1

International Patent Publication No. WO2019/146634

### Patent Literature 2

Published Japanese Translation of PCT International Publication for Patent Application, No. 2022-500295

### SUMMARY

The inventors have found that if a near-field wireless communication antenna is disposed close to a display device as disclosed in Patent Literature 2, noise occurs in an image displayed by the display device.

The present disclosure was made in view of such circumstances and provides a laminated transparent plate capable of reducing noise generated in an image displayed by a display device due to a near-field wireless communication antenna.

One aspect of the present disclosure provides a laminated transparent plate having a configuration [1].
[1] A laminated transparent plate including:
   a pair of transparent plates;
   a display device that is sandwiched between the pair of transparent plates and includes a first substrate and a plurality of display elements formed on the first substrate; and
   a near-field wireless communication antenna that is sandwiched between the pair of transparent plates and includes a second substrate and a spiral coil formed on the second substrate, in which
   the display device and the near-field wireless communication antenna are disposed to overlap each other in plan view, and
   an electromagnetic shield member that includes a third substrate and a metal mesh film formed on the third substrate is provided between the display device and the near-field wireless communication antenna.

In one aspect of the present disclosure:
[2] The laminated transparent plate according to [1], in which a line pitch of the metal mesh film is 100 μm to 6,000 μm, and a line width of the metal mesh film is 3 μm to 200 μm.
[3] The laminated transparent plate according to [1] or [2], in which each of the first to third substrates is transparent, the plurality of display elements are light emitting diode elements that are each arranged for each pixel and have an area of equal to or less than 10,000 μm², and the display device is a transparent display device.
[4] The laminated transparent plate according to any one of [1] to [3], in which the metal mesh film is constituted by metal containing any of Cu, Ni, Fe, and Cr as a main component.
[5] The laminated transparent plate according to any one of [1] to [4], further including: a first drive circuit that drives the display device; and a second drive circuit that drives the near-field wireless communication antenna, in which the first and second drive circuits are both provided outside the pair of transparent plates.
[6] The laminated transparent plate according to [5], in which wirings extending from the pair of transparent plates are electromagnetically shielded in order to connect the near-field wireless communication antenna to the second drive circuit.
[7] The laminated transparent plate according to any one of [1] to [6], in which the pair of transparent plates is a pair of glass plates.
[8] The laminated transparent plate according to [7], further including: a first intermediate film that is provided between one of the pair of glass plates and the display device; and a second intermediate film that is provided between the other one of the pair of glass plates and the near-field wireless communication antenna.
[9] The laminated transparent plate according to any one of [1] to [8], in which the laminated transparent plate is used for a window of a self-driving vehicle, the display device displays a fare of the self-driving vehicle, and a user of the self-driving vehicle pays the fare through communication using the near-field wireless communication antenna.

One aspect of the present disclosure provides a laminated transparent plate having a configuration [10].
[10] A laminated transparent plate including:
   a pair of transparent plates; a display device that is sandwiched between the pair of transparent plates and includes a first substrate and a plurality of light emitting elements formed on the first substrate; and
   a near-field wireless communication antenna that is sandwiched between the pair of transparent plates and includes a second substrate and a spiral coil formed on the second substrate, in which
   the display device and the near-field wireless communication antenna are disposed to be aligned in plan view, and
   an interval between the display device and the near-field wireless communication antenna is equal to or greater than 5 mm.

One aspect of the present disclosure provides method of manufacturing a laminated transparent plate having a configuration [11].
[11] A method of manufacturing a laminated transparent plate in which a display device that includes a first substrate and a plurality of light emitting elements formed on the first substrate and a near-field wireless communication antenna that includes a second substrate and a spiral coil formed on the second substrate are sandwiched between a pair of transparent plates, the method including:
   disposing the display device and the near-field wireless communication antenna to overlap each other in plan view; and
   providing an electromagnetic shield member that includes a third substrate and a metal mesh film formed on the third substrate between the display device and the near-field wireless communication antenna.

One aspect of the present disclosure provides a method of manufacturing a laminated transparent plate having a configuration below.
[12] A method of manufacturing a laminated transparent plate in which a display device that includes a first substrate and a plurality of light emitting elements formed on the first substrate and a near-field wireless communication antenna that includes a second substrate and a spiral coil formed on the second substrate are sandwiched between a pair of transparent plates, the method including:
   disposing the display device and the near-field wireless communication antenna in an aligned manner in plan view; and
   setting an interval between the display device and the near-field wireless communication antenna to be equal to or greater than 5 mm.

According to the present disclosure, it is possible to provide a laminated transparent plate capable of reducing noise generated in an image displayed by a display device due to a near-field wireless communication antenna.

The above and other objects, features and advantages of the present disclosure will become more fully understood from the detailed description given hereinbelow and the accompanying drawings.

### BRIEF DESCRIPTION OF THE DRAWINGS

FIG. 1 is a schematic plan view illustrating an example of a laminated transparent plate according to a first embodiment;

FIG. 2 is a schematic plan view of a display device 100;

FIG. 3 is a schematic plan view of an electromagnetic shield member 300;

FIG. 4 is a sectional view along the cut line IV-IV in FIG. 1;

FIG. 5 is a schematic partial plan view illustrating an example of a display region 101 of the display device 100;

FIG. 6 is a sectional view along the cut line VI-VI in FIG. 5;

FIG. 7 is a sectional view illustrating an example of a method of manufacturing the display device 100;

FIG. 8 is a sectional view illustrating the example of the method of manufacturing the display device 100;

FIG. 9 is a sectional view illustrating the example of the method of manufacturing the display device 100;

FIG. 10 is a sectional view illustrating the example of the method of manufacturing the display device 100;

FIG. 11 is a sectional view illustrating the example of the method of manufacturing the display device 100;

FIG. 12 is a sectional view illustrating the example of the method of manufacturing the display device 100;

FIG. 13 is a sectional view illustrating the example of the method of manufacturing the display device 100;

FIG. 14 is a sectional view illustrating the example of the method of manufacturing the display device 100;

FIG. 15 is a schematic plan view illustrating an example of a laminated transparent plate according to a second embodiment; and

FIG. 16 is a schematic sectional view illustrating an example of a laminated transparent plate according to a third embodiment.

### DESCRIPTION OF EMBODIMENTS

Hereinafter, specific embodiments of the present disclosure will be described in detail with reference to the drawings. However, the present disclosure is not limited to the following embodiments. For clarity of description, the following description and drawings are simplified as appropriate.

In the present specification, a “display device” refers to a display device enabling visual information such as a person, a background, and the like located on the rear surface side of the display device to be visually recognized in a desired utilization environment. Note that whether it is “visually recognized” is determined at least in a non-displaying state of the display device, that is, in a state in which the display device is not energized.

In the present specification, “transparent” means that the transmittance of visible light is equal to or greater than 20%, is preferably equal to or greater than 40%, and is more preferably equal to or greater than 60%. It may also mean that the transmittance is equal to or greater than 5% and the haze value is equal to or less than 20. If the transmittance is equal to or greater than 5%, an outdoor place is seen with brightness that is equal to or greater than that of an indoor place when the outdoor place is seen from the indoor place in daytime, and it is possible to secure sufficient visibility.

If the transmittance is equal to or greater than 40%, the rear surface side of the display device can be visually recognized substantially without any problem even if the brightness of the front surface side and the rear surface side of the display device is about the same. If the haze value is equal to or less than 10, a sufficient contrast of the background can be secured.

In regard to “transparent”, whether any color is applied does not matter, that is, “transparent” may be colorless transparent or colored transparent.

Note that the transmittance refers to a value (%) measured by a method in accordance with ISO 9050. The haze value refers to a value measured by a method in accordance with ISO 14782.

### First Embodiment

### <Configuration of Laminated Transparent Plate>

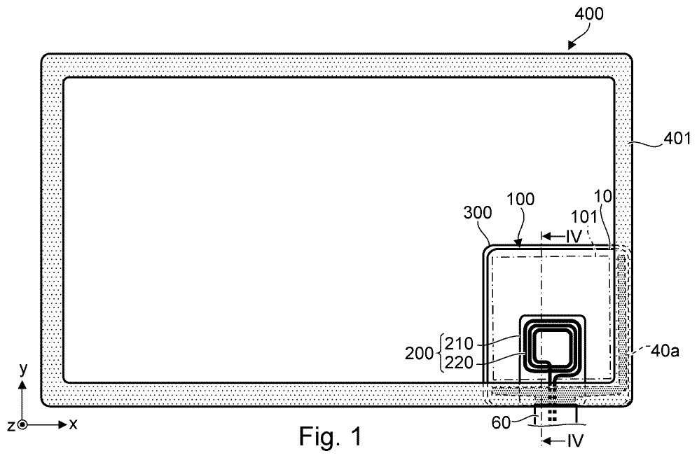

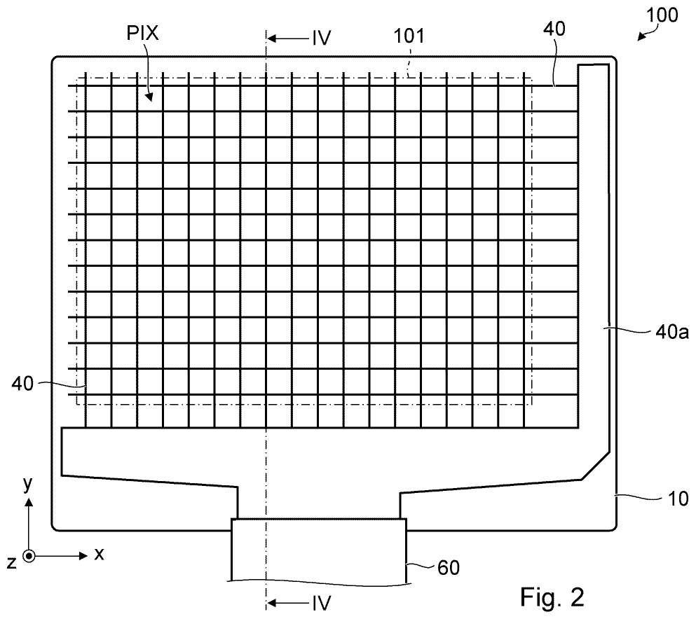

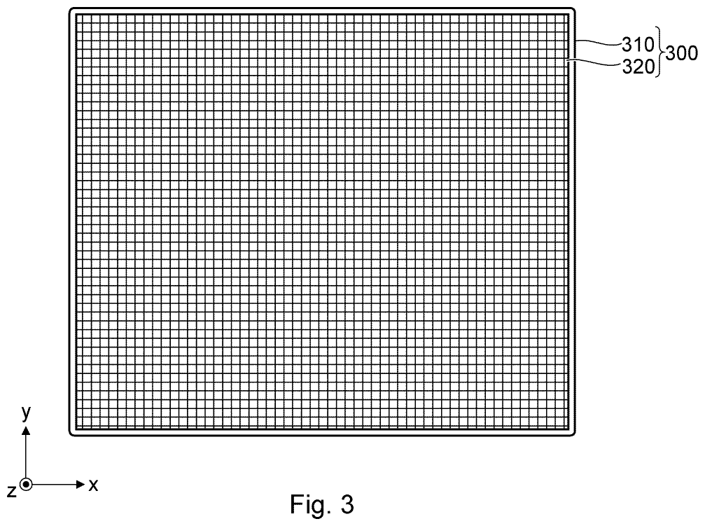

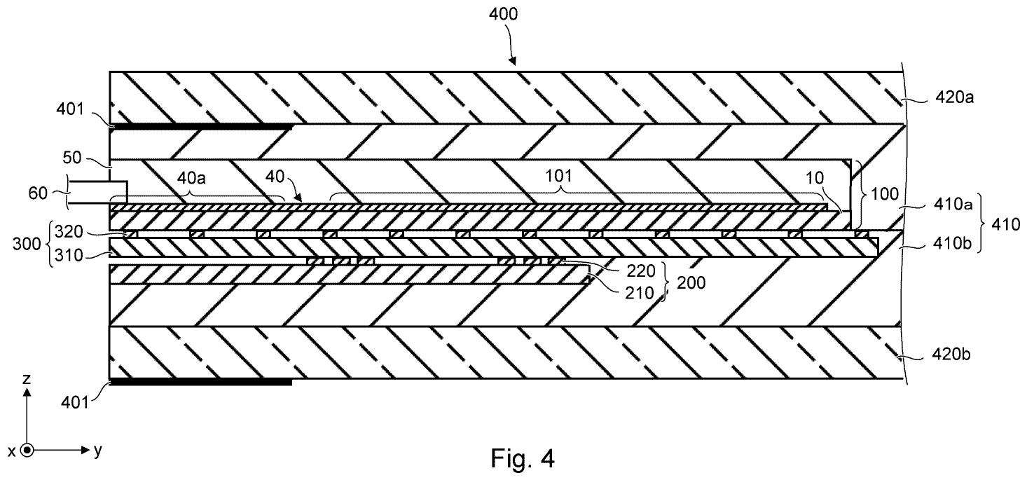

First, a configuration of a laminated transparent plate according to a first embodiment will be described with reference to FIGS. 1 to 4. FIG. 1 is a schematic plan view illustrating an example of the laminated transparent plate according to the first embodiment. FIG. 2 is a schematic plan view of a display device 100. FIG. 3 is a schematic plan view of an electromagnetic shield member 300. FIG. 4 is a sectional view along the cut line IV-IV in FIG. 1.

As illustrated in FIGS. 1 to 4, a laminated transparent plate 400 according to the present embodiment includes a pair of transparent plates 420a and 420b, a display device 100, a near-field wireless communication antenna 200, and an electromagnetic shield member 300.

Note that it is a matter of course that the right-handed xyz orthogonal coordinates illustrated in FIG. 1 and other drawings are for convenience of describing positional relationships among components. Generally, the z-axis positive direction is a vertically upper side, and the xy plane is a horizontal plane, which are common among the drawings.

The laminated transparent plate 400 according to the present embodiment is used, for example, for a window of a self-driving vehicle. Here, the display device 100 displays, for example, a fare of the self-driving vehicle. Then, a user of the self-driving vehicle pays the fare with an integrated circuit (IC) card through communication using the near-field wireless communication antenna 200.

Alternatively, the laminated transparent plate 400 may be used for, for example, an entrance window of a paid facility. Here, the display device 100 displays, for example, an entrance fee of the facility. Then, a user of the facility pays the entrance fee with an IC card through communication using the near-field wireless communication antenna 200.

Note that the display device 100 may display other information such as a remaining balance of the IC card. Furthermore, the laminated transparent plate 400 may be used as a window at an entrance of a room for a user to simply enter the room using an IC card. In this case, a name, an ID number, and the like of the user who enters the room, for example, are displayed on the display device 100.

Here, near-field communication (NFC) using the near-field wireless communication antenna 200 is wireless communication using a frequency of a 13.56 MHz band. As an international standard of the near-field communication, ISO 18092, ISO 14443 Type A, ISO 14443 Type B, and ISO 15693, for example, are known.

The transparent plates 420a and 420b of the laminated transparent plate 400 according to the present embodiment are glass plates. The transparent plates 420a and 420b may be, for example, resin transparent plates such as acrylic plates.

As illustrated in FIG. 4, the laminated transparent plate 400 according to the present embodiment is obtained by bonding the pair of transparent plates 420a and 420b to each other via an intermediate film 410. Specifically, the display device 100, the near-field wireless communication antenna 200, and the electromagnetic shield member 300 are sandwiched between the pair of transparent plates 420a and 420b via the intermediate films 410a and 410b in the laminated transparent plate 400. The intermediate films 410a and 410b are made of, for example, polyvinyl butyral (PVB).

As illustrated in FIG. 4, the transparent plate 420a is disposed to face the display device 100 via the intermediate film 410a. In other words, the transparent plate 420a is disposed on the visible side (vehicle outer side). On the other hand, the transparent plate 420b is disposed to face the near-field wireless communication antenna 200 via the intermediate film 410b. In other words, the transparent plate 420b is disposed on the rear surface side (vehicle inner side). Note that in FIG. 4, the positional relationship between the display device 100 and the near-field wireless communication antenna 200 may be opposite. In other words, the near-field wireless communication antenna 200 may be disposed on the side of the transparent plate 420a while the display device 100 may be disposed on the side of the transparent plate 420b.

As illustrated in FIGS. 1, 2, and 4, the display device 100 is a transparent display device including a transparent substrate (first substrate) 10, wirings 40, and a flexible wiring board 60.

As illustrated in FIG. 1, the display device 100 is provided at an end portion of the laminated transparent plate 400, and the flexible wiring board 60 extends from the transparent plates 420a and 420b.

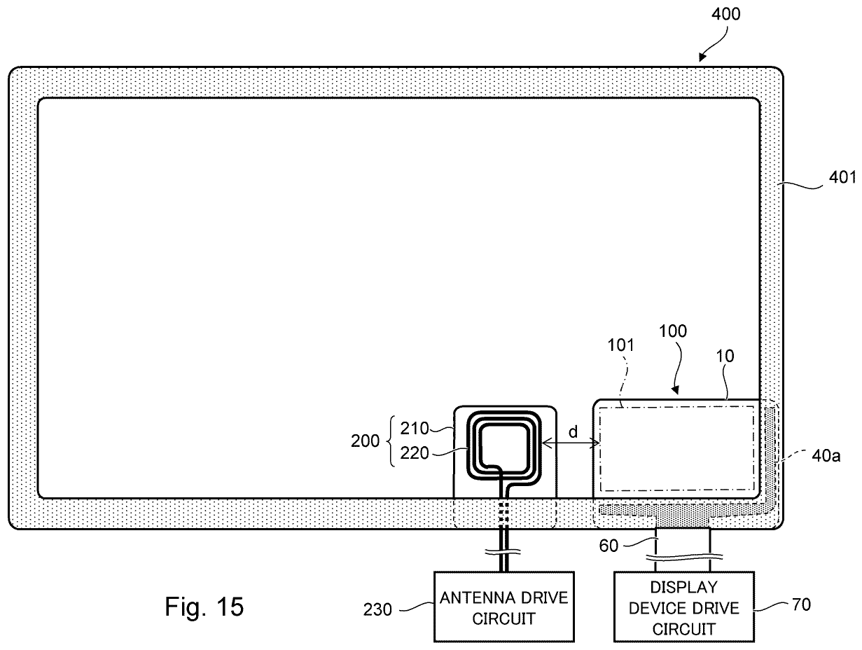

Note that although not illustrated in FIG. 1, the flexible wiring board 60 is connected to a display device drive circuit (first drive circuit) 70 for driving the display device 100 as illustrated in FIG. 15, which will be described later. In other words, the display device drive circuit 70 is provided outside the transparent plates 420a and 420b. The display device drive circuit 70 is opaque. Therefore, visibility on the rear surface side via the transparent plates 420a and 420b is improved by providing the display device drive circuit 70 outside the transparent plates 420a and 420b.

Here, as illustrated in FIGS. 1 and 2, the display device 100 includes a display region 101. As illustrated in FIG. 2, the display region 101 is a region that is constituted by a plurality of pixels PIX and displays an image. Note that the image includes characters. As will be described in detail later, each pixel PIX in the display region 101 includes at least one light emitting diode element (hereinafter, an LED element). In other words, the display device 100 is a display device using a fine LED element as a display element in each pixel and is called an LED display or the like.

No LED elements are formed in a non-display region other than the display region 101.

Note that an organic electro-luminescence (EL) display and an inorganic electro-luminescence (EL) display are also included in LED displays including LED elements as display elements.

In addition, the display device 100 may be a liquid crystal display including liquid crystal elements as display elements instead of the LED elements.

Furthermore, the display device 100 may not be a transparent display device and may use an opaque substrate instead of the transparent substrate 10.

As illustrated in FIG. 2, for example, the transparent substrate 10 includes the display region 101, and the wirings 40 and the LED elements connected to the wirings 40 are formed on one main surface of the transparent substrate 10. Here, the LED elements are an example of fine electronic elements each having an area of equal to or less than 250,000 μm².

Here, the wirings 40 illustrated linearly in FIG. 2 extend in the x-axis direction and the y-axis direction. The wirings 40 extending in the x-axis direction have a wide width at an end portion of the transparent substrate 10 on the x-axis positive direction side, extend in the y-axis negative direction, and are then connected to the flexible wiring board 60. In other words, at least parts of portions of the wirings 40 extending in the y-axis negative direction are thicker than the portions extending in the x-axis direction. Moreover, the wirings 40 extending in the y axis direction have a wide width at an end portion of the transparent substrate 10 on the y-axis negative direction side and are connected to the flexible wiring board 60. In other words, at portions of the wirings 40 extending in the y-axis direction, the width thereof at one end in the y-axis negative direction is thicker than that at one end in the y-axis positive direction.

In FIGS. 1 and 2, an opaque region where the wirings 40 are formed to have a wide width is schematically illustrated as an opaque wiring region 40a. In practice, the wirings 40 with a wide width are provided as a densely packed wiring group in the opaque wiring region 40a. Therefore, it is also possible to state that at least parts of the portions of the wiring 40 extending in the opaque wiring region 40a are thicker than the portions extending in the display region 101. Note that the wirings 40 may have substantially the same line width at the portions in the x-axis direction (display region portion) and the y direction (opaque wiring region 40a) and may form a mesh-shaped wiring group in the opaque wiring region 40a.

Note that each of the wirings 40 drawn in one line shape in FIG. 1 is constituted by a plurality of fine wirings as will be described later.

As will be described in detail later, the width of the fine wirings 40 is, for example, 1 μm to 100 μm, and is preferably 3 μm to 20 μm. Since the width of the wirings 40 is equal to or less than 100 μm, the wirings 40 are hardly visible even in a case where the laminated transparent plate is observed from a short distance of several tens of centimeters to about 2 meters, for example, and visibility on the rear surface side is excellent.

On the other hand, the width of the wirings 40 in the opaque wiring region 40a is, for example, 100 μm to 10,000 μm, and is preferably 100 μm to 5,000 μm. Intervals between the wirings are, for example, 3 μm to 5,000 μm, and are preferably 50 μm to 1,500 μm. The wirings 40 in the opaque wiring region 40a can be visually recognized. Therefore, the opaque wiring region 40a formed in a substantially L shape in the xy plan view along the peripheral edge portion of the display device 100 is covered and hidden by some means, for example.

The flexible wiring board 60 is a strip-shaped power feeder for feeding power to the display region 101. Since the flexible wiring board 60 is opaque, the flexible wiring board 60 is connected to end portions of the wirings 40 formed at an edge portion of the transparent substrate 10. In the example illustrated in FIGS. 1, 2, and 4, the flexible wiring board 60 is connected to the end portions of the wirings 40 in the opaque wiring region 40a formed at the end portion of the transparent substrate 10 on the y-axis negative direction side. Similarly to the opaque wiring region 40a, the flexible wiring board 60 is also covered and hidden by some means, for example. The flexible wiring board 60 may be electromagnetically shielded.

In the laminated transparent plate 400 illustrated in FIG. 1, strip-shaped shielding layers 401 are provided on the entire peripheral edge thereof. Since the shielding layers 401 shield sunlight, it is possible to curb deterioration of an adhesive (for example, a resin such as urethane) for assembling the laminated transparent plate 400 with a vehicle due to ultraviolet rays.

Note that although FIG. 1 is a plan view, the shielding layers 401 and the opaque wiring region 40a are indicated by dots for easy understanding.

When the laminated transparent plate 400 illustrated in FIG. 4 is attached to the vehicle, the shielding layers 401 are formed on a surface of the transparent plate 420a on the vehicle inner side and a surface of the transparent plate 420b on the vehicle inner side.

Note that the shielding layer 401 may be formed on only one of the transparent plate 420a and the transparent plate 420b. Moreover, the shielding layers 401 may be formed on the surfaces of the transparent plate 420a and the transparent plate 420b on the vehicle outer side.

Here, as illustrated in FIGS. 1 and 4, the shielding layers 401 are formed to overlap the flexible wiring board 60 and the opaque wiring region 40a. Therefore, the flexible wiring board 60 and the opaque wiring region 40a are less likely to be visually recognized from the vehicle inner side and the vehicle outer side, and design of the laminated transparent plate 400 is improved.

Although the shielding layers 401 are not particularly limited, the shielding layers 401 can be formed, for example, by applying and firing a ceramic color paste containing a meltable glass frit containing a pigment. For example, an organic ink containing a pigment may be applied and dried to form the shielding layers 401. The shielding layers 401 may be formed of colored films. Although the color of the pigment and the color of the colored films may be any color as long as visible light can be shielded to such an extent that at least a portion that is required to be hidden can be hidden, a dark color is preferable, and a black color is more preferable. Also, the shielding layers 401 are preferably opaque.

As illustrated in FIGS. 1 and 4, the near-field wireless communication antenna 200 includes a transparent substrate (second substrate) 210 and a coil 220.

As illustrated in FIG. 1, the coil 220 is spirally patterned wiring and is formed on the transparent substrate 210. The coil 220 is constituted by, for example, a metal film of copper (Cu), aluminum (Al), silver (Ag), gold (Au), or the like. Among these, metal containing copper or aluminum as a main component is preferable from the viewpoint of low resistivity and cost. The coil 220 may be constituted by a so-called metal oxide-based transparent conductive film of tin oxide (SnO₂), indium oxide (In₂O₃), zinc oxide (ZnO), or the like.

The transparent substrate 210 is constituted by a material similar to that of the transparent substrate 10, which will be described later in detail.

As illustrated in FIG. 1, the near-field wireless communication antenna 200 is disposed to overlap the display device 100 in plan view. Also, a wiring for driving the coil 220, that is, the near-field wireless communication antenna 200 extends from the transparent plates 420a and 420b. In the present embodiment, the wiring for driving the near-field wireless communication antenna 200 is electromagnetically shielded. With such a configuration, it is possible to more effectively reduce noise generated in an image displayed by the display device 100 due to the near-field wireless communication antenna 200.

Note that although not illustrated in FIG. 1, an antenna drive circuit (second drive circuit) 230 for driving the near-field wireless communication antenna 200 is provided outside the transparent plates 420a and 420b as illustrated in FIG. 15, which will be described later. The antenna drive circuit 230 is opaque. Therefore, visibility on the rear surface side via the transparent plates 420a and 420b is improved by providing the antenna drive circuit 230 outside the transparent plates 420a and 420b.

As illustrated in FIGS. 3 and 4, the electromagnetic shield member 300 includes a transparent substrate (third substrate) 310 and a metal mesh film 320.

The transparent substrate 310 is constituted by a material similar to that of the transparent substrate 10, which will be described later in detail.

As illustrated in FIG. 3, the metal mesh film 320 is a metal film patterned in a mesh shape and is formed on the transparent substrate 310. For example, the metal mesh film 320 is configured in a mesh shape by a plurality of metal wires extending in the x-axis direction and a plurality of metal wires extending in the y-axis direction intersecting each other. Here, the plurality of metal wires extending in the x-axis direction or the y-axis direction are not limited to a linear shape and may be formed in a sine wave shape or a triangular wave shape.

The metal mesh film 320 is, for example, metal containing any of copper (Cu), nickel (Ni), iron (Fe), and chromium (Cr) as a main component.

The line width of the metal mesh film 320 is, for example, 3 μm to 200 μm. The line width of the metal mesh film 320 is preferably 5 μm to 100 μm, and is further preferably 5 μm to 50 μm. The larger the line width is, the better the electromagnetic shielding performance becomes, and the smaller the line width is, the better the visibility becomes.

The thickness of the metal mesh film 320 is, for example, 0.1 μm to 5.0 μm. The thickness of the metal mesh film 320 is preferably 0.3 μm to 3.0 μm, and is further preferably 0.4 μm to 2.0 μm. The larger the thickness is, the better the electromagnetic shielding performance becomes.

The line pitch of the metal mesh film 320 is, for example, 100 μm to 6,000 μm. The line pitch of the metal mesh film 320 is preferably 200 μm to 4,000 μm, and is further preferably 300 μm to 3,000 μm. The larger the line pitch is, the better the visibility becomes, and the smaller the line pitch is, the better the electromagnetic shielding performance becomes.

As illustrated in FIGS. 1 and 4, the electromagnetic shield member 300 is provided between the display device 100 and the near-field wireless communication antenna 200 that are disposed to overlap each other in plan view. With such a configuration, it is possible to reduce noise generated in an image displayed by the display device 100 due to the near-field wireless communication antenna 200.

Here, as illustrated in FIG. 1, the electromagnetic shield member 300 preferably overlaps the entire near-field wireless communication antenna 200 in plan view. Furthermore, the electromagnetic shield member 300 preferably overlaps the entire display device 100 in plan view. With such a configuration, the laminated transparent plate 400 according to the present embodiment can more effectively reduce noise generated in an image displayed by the display device 100 due to the near-field wireless communication antenna 200.

Note that although the near-field wireless communication antenna 200 is disposed such that the entire near-field wireless communication antenna 200 overlaps the display device 100 in FIG. 1, the near-field wireless communication antenna 200 may be disposed such that a part thereof overlaps the display device 100. In this case, the electromagnetic shield member 300 may be disposed only in a region where the near-field wireless communication antenna 200 and the display device 100 overlap each other, or may be disposed to overlap only either the entire near-field wireless communication antenna 200 or the entire display device 100.

As described above, the electromagnetic shield member 300 is provided between the display device 100 and the near-field wireless communication antenna 200 that are disposed to overlap each other in plan view in the laminated transparent plate 400 according to the present embodiment. Therefore, the laminated transparent plate 400 according to the present embodiment can reduce noise generated in an image displayed by the display device 100 due to the near-field wireless communication antenna 200.

### <Detailed Configuration of Display Region 101>

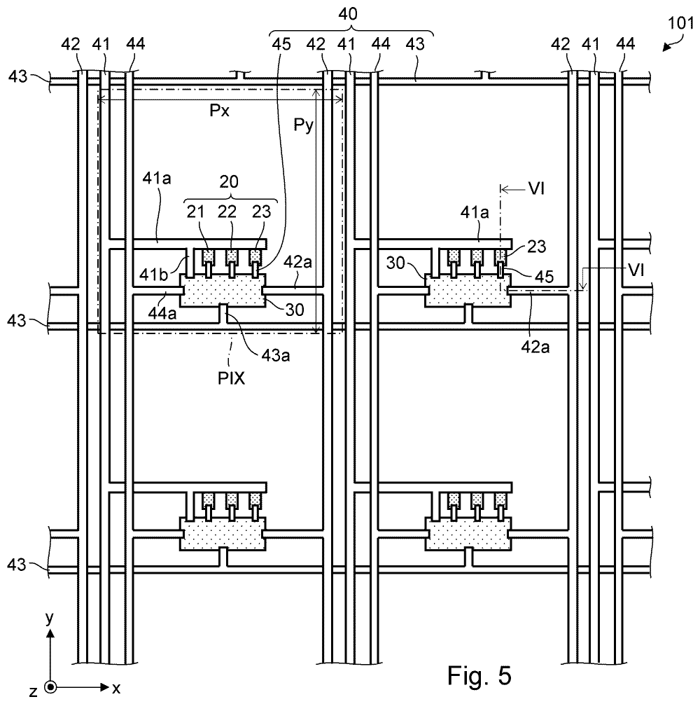

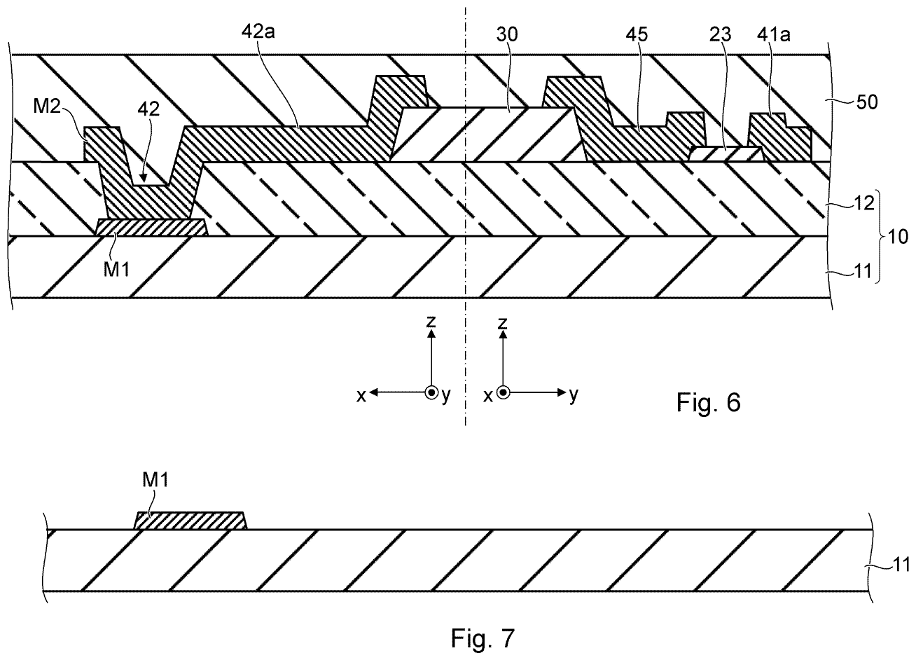

Next, a detailed configuration of the display region 101 of the display device 100 will be described with reference to FIGS. 5 and 6. FIG. 5 is a schematic partial plan view illustrating an example of the display region 101 of the display device 100. FIG. 6 is a sectional view along the cut line VI-VI in FIG. 5.

As illustrated in FIGS. 5 and 6, the display device 100 is a transparent display device including the transparent substrate 10, a light emitting unit 20, an integrated circuit (IC) chip 30, the wirings 40, and a protective layer 50. The display region 101 is a region that is constituted by a plurality of pixels and displays an image. Note that the image includes characters. As illustrated in FIG. 2, the display region 101 is constituted by the plurality of pixels PIX aligned in a row direction (x-axis direction) and a column direction (y-axis direction).

Note that FIG. 5 illustrates a part of the display region 101 and illustrates a total of four pixels including two pixels in each of the row direction and the column direction. Here, one pixel PIX is surrounded by the one-dotted dashed line. Also, the transparent substrate 10 and the protective layer 50 illustrated in FIG. 6 are omitted in FIG. 5. Furthermore, FIG. 5 is a plan view, and the light emitting unit 20 and the IC chip 30 are indicated by dots for easy understanding.

### <Planar Arrangement of Light Emitting Unit 20, IC Chip 30, and Wirings 40>

First, planar arrangement of the light emitting unit 20, the IC chip 30, and the wirings 40 will be described with reference to FIG. 5.

As illustrated in FIG. 5, the pixel PIX surrounded by the one-dotted dashed line is arranged in a matrix shape at a pixel pitch Px in the row direction (x-axis direction) and at a pixel pitch Py in the column direction (y-axis direction). Here, each pixel PIX includes the light emitting unit 20 and the IC chip 30 as illustrated in FIG. 5. In other words, the light emitting unit 20 and the IC chip 30 are arranged in a matrix shape at the pixel pitch Px in the row direction (x-axis direction) and at the pixel pitch Py in the column direction (y-axis direction).

Note that the arrangement form of the pixels PIX, that is, the light emitting units 20 is not limited to the matrix shape as long as they are arranged at a predetermined pixel pitch in a predetermined direction.

As illustrated in FIG. 5, the light emitting unit 20 in each pixel PIX includes at least one LED element.

In the example of FIG. 5, each light emitting unit 20 includes a red LED element 21, a green LED element 22, and a blue LED element 23. The LED elements 21 to 23 correspond to sub-pixels (sub-pixels) constituting one pixel. Since each light emitting unit 20 includes the LED elements 21 to 23 emitting light of red, green, and blue colors, which are three primary colors of light in this manner, the display device according to the present embodiment can display a full-color image.

Note that each light emitting unit 20 may include two or more LED elements of similar colors. It is thus possible to expand a dynamic range of the image.

The LED elements 21 to 23 have a minute size and are so-called micro LED elements. Specifically, each of the width (the length in the x-axis direction) and the length (the length in the y-axis direction) of the LED element 21 on the transparent substrate 10 is equal to or less than 100 μm, is preferably equal to or less than 50 μm, and is more preferably equal to or less than 20 μm, for example. The same applies to the LED elements 22 and 23. The lower limit of the width and the length of the LED element is, for example, equal to or greater than 3 μm from various manufacturing conditions and the like.

Note that although the dimensions, that is, the widths and the lengths of the LED elements 21 to 23 in FIG. 5 are the same, the dimensions thereof may be different from each other.

The area occupied by each of the LED elements 21 to 23 on the transparent substrate 10 is equal to or less than 10,000 μm², is preferably equal to or less than 3,000 μm², and is more preferably equal to or less than 500 μm², for example. Note that the lower limit of the area occupied by one LED element is, for example, equal to or greater than 10 μm² from various manufacturing conditions and the like. Here, in the present specification, the areas occupied by components such as the LED elements, the wirings, and the like refer to areas in view of the xy plane in FIG. 5.

Note that although the shape of the LED elements 21 to 23 illustrated in FIG. 5 is a rectangular shape (including a square shape), the shape is not particularly limited.

Here, since the LED elements 21 to 23 have, for example, a mirror structure for efficiently extracting light on the visible side, the transmittance of the LED elements 21 to 23 is as low as about 10% or less, for example. However, the LED elements 21 to 23 having a minute size with an area of equal to or less than 10,000 μm2 are used as described above in the display device according to the present embodiment. Therefore, the LED elements 21 to 23 are hardly visible even in a case where the display device is observed from a short distance of about several tens of centimeters to about 2 meters, for example. In addition, a region having a low transmittance in the display region 101 is narrow, and visibility on the rear surface side is excellent. In addition, a degree of freedom in arrangement of the wirings 40 and the like is also high.

Note that “the region having a low transmittance in the display region 101” is, for example, a region where the transmittance is equal to or less than 20%. The same applies the following description.

In addition, since the LED elements 21 to 23 having minute sizes are used, the LED elements are unlikely to be damaged even if the display device is curved. Therefore, the display device according to the present embodiment can be used by being mounted on a curved transparent plate such as a window glass for an automobile or by being enclosed between two curved transparent plates. Here, the display device according to the present embodiment can be curved by using a material with flexibility as the transparent substrate 10.

Although the LED elements 21 to 23 are not particularly limited, the LED elements 21 to 23 are, for example, inorganic materials. The red LED element 21 is, for example, AlGaAs, GaAsP, GaP, or the like. The green LED element 22 is, for example, InGaN, GaN, AlGaN, GaP, AlGaInP, ZnSe, or the like. The blue LED element 23 is, for example, InGaN, GaN, AlGaN, ZnSe, or the like.

Light emission efficiency, that is, energy conversion efficiency of the LED elements 21 to 23 is equal to or greater than 1%, is preferably equal to or greater than 5%, and is more preferably equal to or greater than 15%, for example. If the light emission efficiency of the LED elements 21 to 23 is equal to or greater than 1%, sufficient luminance can be obtained even with the LED elements 21 to 23 having a minute size as described above, and the display device can be used even during daytime. In addition, if the light emission efficiency of the LED elements is equal to or greater than 15%, heat generation is curbed, and encapsulation inside the laminated glass using a resin adhesive layer is facilitated.

Each of the pixel pitches Px and Py is 100 μm to 3,000 μm, is preferably 180 μm to 1,000 μm, and is more preferably 250 μm to 400 μm, for example. It is possible to realize high transparency while securing a sufficient display capability by setting the pixel pitches Px and Py within the above range. In addition, it is possible to curb a diffraction phenomenon that can be caused by light from the rear surface side of the display device.

Furthermore, the pixel density in the display region 101 of the display device according to the present embodiment is equal to or greater than 10 ppi, is preferably equal to or greater than 30 ppi, and is more preferably equal to or greater than 60 ppi, for example.

In addition, the area of one pixel PIX is Px×Py, and this area is 1×10⁴ μm² to 9×10⁶ μm², is preferably 3×10⁴ μm² to 1×10⁶ μm², and is more preferably 6×10⁴ μm² to 2×10⁵ μm², for example. It is possible to improve transparency of the display device while securing an appropriate display capability by setting the area of one pixel to 1×10⁴ μm² to 9×10⁶ μm². The area of one pixel may be appropriately selected in accordance with the size, an application, a viewing distance, and the like of the display region 101.

The proportion of the area occupied by the LED elements 21 to 23 to the area of one pixel is equal to or less than 30%, is preferably equal to or less than 10%, is more preferably equal to or less than 5%, and is further preferably equal to or less than 1%, for example. Transparency and visibility on the rear surface side are improved by setting the proportion of the area occupied by the LED elements 21 to 23 to the area of one pixel to be equal to or less than 30%.

Although the three LED elements 21 to 23 are arranged to be aligned in one line in the x-axis positive direction in this order in each pixel in FIG. 5, the present disclosure is not limited thereto. For example, the arrangement order of the three LED elements 21 to 23 may be changed. In addition, the three LED elements 21 to 23 may be aligned in the y-axis direction. Alternatively, the three LED elements 21 to 23 may be arranged at vertices of a triangle.

Furthermore, in a case in which each light emitting unit 20 includes the plurality of LED elements 21 to 23 as illustrated in FIG. 5, the intervals of the LED elements 21 to 23 in the light emitting unit 20 are equal to or less than 100 μm, and are preferably equal to or less than 10 μm, for example. Also, the LED elements 21 to 23 may be disposed to be in contact with each other. In this manner, a first power supply branch line 41a can be easily shared, and an aperture ratio can be improved.

Note that although the arrangement order, the arrangement direction, and the like of the plurality of LED elements in each light emitting unit 20 are the same in the example of FIG. 5, these may be different. Furthermore, in a case where each light emitting unit 20 includes three LED elements that emit light having different wavelengths, the LED elements may be arranged to be aligned in the x-axis direction or the y-axis direction in some of the light emitting units 20, while the LED elements of each color may be arranged at vertices of a triangle in other light emitting units 20.

In the example of FIG. 5, the IC chip 30 is arranged for each pixel PIX and drives the light emitting unit 20. Specifically, the IC chip 30 is connected to each of the LED elements 21 to 23 via drive lines 45 and can individually drive the LED elements 21 to 23. The IC chip 30 is, for example, a hybrid IC including an analog region and a logic region. The analog region includes, for example, a current control circuit, a transformer circuit, and the like.

Note that the IC chip 30 may be arranged for a plurality of pixels and each IC chip 30 may drive the plurality of connected pixels. If one IC chip 30 is arranged for every four pixels, for example, the number of IC chips 30 can be reduced to ¼ of the number thereof in the example of FIG. 5, and it is possible to reduce the area occupied by the IC chips 30. Further, the IC chip 30 is not essential.

The area of one IC chip 30 is equal to or less than 100,000 μm², is preferably equal to or less than 10,000 μm², and is more preferably equal to or less than 5,000 μm², for example. Although the transmittance of the IC chips 30 is as low as about 20% or less, the region having a low transmittance in the display region 101 becomes narrow, and visibility on the rear surface side is improved by using the IC chips 30 having the above size.

As illustrated in FIG. 5, the wirings 40 include a plurality of power supply lines 41, a plurality of ground lines 42, a plurality of row data lines 43, a plurality of column data lines 44, and a plurality of drive lines 45.

In the example of FIG. 5, the power supply lines 41, the ground lines 42, and the column data lines 44 extend in the y-axis direction. On the other hand, the row data lines 43 extend in the x-axis direction.

In each pixel PIX, the power supply line 41 and the column data line 44 are provided on the side closer to the x-axis negative direction than the light emitting unit 20 and the IC chip 30, and the ground line 42 is provided on the side closer to the x-axis positive direction than the light emitting unit 20 and the IC chip 30. Here, power supply line 41 is provided on the side closer to the x-axis negative direction than the column data line 44. In each pixel PIX, the row data line 43 is provided on the side closer to the y-axis negative direction than the light emitting unit 20 and the IC chip 30.

Although detailed description is given later, the power supply line 41 includes a first power supply branch line 41a and a second power supply branch line 41b as illustrated in FIG. 5. The ground line 42 includes a ground branch line 42a. The row data line 43 includes a row data branch line 43a. The column data line 44 includes a column data branch line 44a. Each of these branch lines is included in the wirings 40.

As illustrated in FIG. 5, each power supply line 41 extending in the y-axis direction is connected to the light emitting unit 20 and the IC chip 30 of each of the pixels PIX provided to be aligned in the y-axis direction. More specifically, the LED elements 21 to 23 are provided to be aligned in the x-axis positive direction in this order on the side closer to the x-axis positive direction than the power supply line 41 in each pixel PIX. Therefore, the first power supply branch line 41a branched from the power supply line 41 in x-axis positive direction is connected to the end portions of the LED elements 21 to 23 on the y-axis positive direction side.

In each pixel PIX, the IC chip 30 is disposed on the y-axis negative direction side of the LED elements 21 to 23. Therefore, the second power supply branch line 41b branched from the first power supply branch line 41a in y-axis negative direction extends linearly and is connected to the x-axis negative direction side of the end portion of the IC chip 30 on the y-axis positive direction side, between the LED element 21 and the column data line 44.

As illustrated in FIG. 5, each ground line 42 extending in the y-axis direction is connected to the IC chip 30 of each of the pixels PIX provided to be aligned in the y-axis direction. Specifically, the ground branch line 42a branching in the x-axis negative direction from the ground line 42 extends linearly and is connected to the end portion of the IC chip 30 on the x-axis positive direction side.

Here, the ground line 42 is connected to the LED elements 21 to 23 via the ground branch line 42a, the IC chip 30, and the drive lines 45.

As illustrated in FIG. 5, each row data line 43 extending in the x-axis direction is connected to the IC chip 30 of each of the pixels PIX provided to be aligned in the x-axis direction (row direction). Specifically, the row data line branch line 43a branching from the row data line 43 in the y-axis positive direction extends linearly and is connected to the end portion of the IC chip 30 on the y-axis negative direction side.

Here, the row data line 43 is connected to the LED elements 21 to 23 via the row data branch line 43a, the IC chip 30, and the drive lines 45.

As illustrated in FIG. 5, each column data line 44 extending in the y-axis direction is connected to the IC chip 30 of each of the pixels PIX provided to be aligned in the y-axis direction (column direction). Specifically, the column data branch line 44a branching from the column data line 44 in the x-axis positive direction extends linearly and is connected to the end portion of the IC chip 30 in the x-axis negative direction side.

Here, the column data line 44 is connected to the LED elements 21 to 23 via the column data branch line 44a, the IC chip 30, and the drive lines 45.

In each pixel PIX, the drive lines 45 connect the LED elements 21 to 23 to the IC chip 30. Specifically, in each pixel PIX, the three drive lines 45 extend in the y-axis direction, and each of the drive lines 45 connects the end portion of each of the LED elements 21 to 23 on the y-axis negative direction side to the end portion of the IC chip 30 on the y-axis positive direction side.

Note that the arrangement of the power supply line 41, the ground line 42, the row data line 43, the column data line 44, the branch lines thereof, and the drive lines 45 illustrated in FIG. 5 is merely an example and can be changed as appropriate. For example, at least either the power supply line 41 or the ground line 42 may extend in the x-axis direction instead of the y-axis direction. Also, a configuration in which the power supply line 41 and the column data line 44 are replaced may be adopted.

In addition, a configuration obtained by vertically inverting the entire configuration illustrated in FIG. 5, a configuration obtained by horizontally inverting the entire configuration illustrated in FIG. 5, or the like may also be adopted.

Furthermore, the row data line 43, the column data line 44, the branch lines thereof, and the drive lines 45 are not essential.

The wirings 40 are metal such as copper (Cu), aluminum (Al), silver (Ag), or gold (Au), for example. Among these, metal containing copper or aluminum as a main component is preferable from the viewpoint of low resistivity and cost. Furthermore, the wirings 40 may be covered with a material such as titanium (Ti), molybdenum (Mo), copper oxide, or carbon for the purpose of reducing reflectance. Furthermore, irregularities may be formed on the surface of the covered material.

The width of all the wirings 40 in the display region 101 illustrated in FIG. 5 is 1 μm to 100 μm, and is preferably 3 μm to 20 μm, for example. If the width of the wirings 40 is equal to or less than 100 μm, the wirings 40 are hardly visible even in a case where the display device is observed from a short distance of several tens of centimeters to about 2 meters, for example, and visibility on the rear surface side is excellent. On the other hand, in the case of the range of the thickness, which will be described later, it is possible to curb an excessive rise of resistance of the wirings 40 and to curb a voltage drop and signal intensity drop if the width of the wirings 40 is equal to or greater than 1 μm. In addition, a decrease in heat conductivity due to the wirings 40 can also be curbed.

Here, in a case where the wirings 40 mainly extend in the x-axis direction and the y-axis direction as illustrated in FIG. 5, a cross diffraction image extending in the x-axis direction and the y-axis direction may be generated by light emitted from the outside of the display device, and the visibility on the rear surface side of the display device may be degraded. This diffraction can be suppressed, and the visibility on the rear surface side can be further improved by reducing the width of each wiring. The width of the wirings 40 is equal to or less than 50 μm, is preferably equal to or less than 10 μm, and is more preferably equal to or less than 5 μm from the viewpoint of curbing diffraction.

The electrical resistivity of the wirings 40 is equal to or less than 1.0×10⁻⁶ Ωm, and is preferably equal to or less than 2.0×10⁻⁸ Ωm, for example. The thermal conductivity of the wirings 40 is 150 W/(m·K) to 5500 W/(m·K), and is preferably 350 W/(m·K) to 450 W/(m·K), for example.

The intervals between the adjacent wirings 40 in the display region 101 illustrated in FIG. 5 are 3 μm to 100 μm, and are preferably 5 μm to 30 μm, for example. If there is a region where the wirings 40 are dense, visual recognition on the rear surface side may be hindered. If the intervals between the adjacent wirings 40 are equal to or greater than 3 μm, it is possible to curb such hindrance of visual recognition. On the other hand, if the intervals between the adjacent wirings 40 are equal to or less than 100 μm, it is possible to secure a sufficient display capability.

Note that in a case where the intervals between the adjacent wirings 40 are not constant due to curving of the wirings 40 or the like, the intervals between the adjacent wirings 40 described above indicate the minimum value thereof.

The proportion of the area occupied by the wirings 40 to the area of one pixel is equal to or less than 30%, is preferably equal to or less than 10%, is more preferably equal to or less than 5%, and is further preferably equal to or less than 3%, for example. The transmittance of the wirings 40 is as low as 20% or less or 10% or less, for example. However, a region having low transmittance in the display region 101 becomes narrow, and the visibility on the rear surface side is improved, by setting the proportion of the area occupied by the wirings 40 in one pixel to be equal to or less than 30%.

Furthermore, a sum of areas occupied by the light emitting unit 20, the IC chip 30, and the wirings 40 to the area of one pixel is equal to or less than 30%, is preferably equal to or less than 20%, and is more preferably equal to or less than 10%, for example.

### <Sectional Configuration of Display Region 101>

Next, a sectional configuration of the display region 101 formed on the transparent substrate 10 in the display device 100 will be described with reference to FIG. 6.

The transparent substrate 10 is a transparent material having an insulating property. In the example of FIG. 6, the transparent substrate 10 has a two-layer structure including a main substrate 11 and an adhesive layer 12.

As will be described in detail later, the main substrate 11 is, for example, a transparent resin.

The adhesive layer 12 is, for example, a transparent resin adhesive of an epoxy type, an acrylic type, a silicone type, an olefin type, a polyimide type, a novolac type, or the like.

Note that the main substrate 11 may be a thin glass plate having a thickness of equal to or less than 200 μm, and is preferably equal to or less than 100 μm, for example. Also, the adhesive layer 12 is not essential.

Examples of the transparent resin constituting the main substrate 11 include polyester-based resins such as polyethylene terephthalate (PET) and polyethylene naphthalate (PEN), olefin-based resins such as a cycloolefin polymer (COP) and a cycloolefin copolymer (COC), cellulose-based resins such as cellulose, acetyl cellulose, and triacetyl cellulose (TAC), imide-based resins such as polyimide (PI), amide-based resins such as polyamide (PA), amideimide-based resins such as polyamideimide (PAI), carbonate-based resins such as polycarbonate (PC), sulfone-based resins such as polyethersulfone (PES), paraxylene-based resins such as polyparaxylene, vinyl-based resins such as polyethylene (PE), polyvinyl chloride (PVC), polystyrene (PS), polyvinyl acetate (PVAc), polyvinyl alcohol (PVA), and polyvinyl butyral (PVB), and acrylic-based resins such as polymethyl methacrylate (PMMA), an ethylene-vinyl acetate copolymer resin (EVA), a urethane-based resins such as thermoplastic polyurethane (TPU), and epoxy-based resins.

Among the materials used for the main substrate 11 described above, polyethylene naphthalate and polyimide are preferable from the viewpoint of improving heat resistance. In addition, a cycloolefin polymer, a cycloolefin copolymer, polyvinyl butyral, and the like are preferable from the viewpoint of having low birefringence indexes and capable of reducing distortion and smearing of an image viewed through the transparent insulating substrate.

The above materials may be used alone, or two or more kinds of materials may be mixed and used. Furthermore, the main substrate 11 may be constituted by laminating flat plates of different materials.

The thickness of the entire transparent substrate 10 is 1 μm to 1,000 μm, and is preferably 5 μm to 200 μm, for example. The visible light internal transmittance of the transparent substrate 10 is equal to or greater than 50%, is preferably equal to or greater than 70%, and is more preferably equal to or greater than 90%, for example.

Also, the transparent substrate 10 may have flexibility. In this manner, it is possible to use the transparent display device by mounting it on a curved transparent plate or sandwiching it between two curved transparent plates, for example. In addition, the transparent substrate 10 may be a material that contracts when heated to 100° C. or higher.

As illustrated in FIG. 6, the LED elements 21 to 23 and the IC chip 30 are provided on the transparent substrate 10, that is, the adhesive layer 12, and are connected to the wirings 40 disposed on the transparent substrate 10. In the example of FIG. 6, the wirings 40 are constituted by a first metal layer M1 formed on the main substrate 11 and a second metal layer M2 formed on the adhesive layer 12.

The thickness of the wirings 40, that is, the sum of the thickness of the first metal layer M1 and the thickness of the second metal layer M2 is from 0.1 μm to 10 μm, and is preferably 0.5 μm to 5 μm, for example. The thickness of the first metal layer M1 is about 0.5 μm, for example, while the thickness of the second metal layer M2 is about 3 μm, for example.

Specifically, as illustrated in FIG. 6, the ground line 42 extending in the y-axis direction has a two-layer structure including the first metal layer M1 and the second metal layer M2 since the amount of current is large. In other words, the adhesive layer 12 is removed and the second metal layer M2 is formed on the first metal layer M1 at a place where the ground line 42 is provided. Although not illustrated in FIG. 6, the power supply line 41, the row data line 43, and the column data line 44 illustrated in FIG. 5 similarly have a two-layer structure including the first metal layer M1 and the second metal layer M2.

Here, the power supply line 41, the ground line 42, and the column data line 44 extending in the y-axis direction intersect the row data line 43 extending in the x-axis direction as illustrated in FIG. 5. Although not illustrated in FIG. 6, the row data line 43 is constituted only by the first metal layer M1, and the power supply line 41, the ground line 42, and the column data line 44 are constituted only by the second metal layer M2 at the intersection. At this intersection, the adhesive layer 12 is provided between the first metal layer M1 and the second metal layer M2, and the first metal layer M1 and the second metal layer M2 are insulated from each other.

Similarly, the first power supply branch line 41a is constituted only by the first metal layer M1, and the column data line 44 is constituted only by the second metal layer M2 at the intersection between the column data line 44 and the first power supply branch line 41a illustrated in FIG. 5.

In the example of FIG. 6, the ground branch line 42a, the drive line 45, and the first power supply branch line 41a are constituted only by the second metal layer M2 and are formed to cover end portions of the LED elements 21 to 23 and the IC chip 30. Although not illustrated in FIG. 6, the second power supply branch line 41b, the row data branch line 43a, and the column data branch line 44a are similarly constituted only by the second metal layer M2.

Note that the first power supply branch line 41a is constituted only by the first metal layer M1 at the intersection with the column data line 44 as described above, and is constituted only by the second metal layer M2 at the other locations. In addition, a metal pad made of copper, silver, gold, or the like may be arranged on the wirings 40 formed on the transparent substrate 10, and at least either the LED elements 21 to 23 or the IC chip 30 may be disposed thereon.

The protective layer 50 is a transparent resin formed on substantially the entire surface of the transparent substrate 10 to cover and protect the light emitting unit 20, the IC chip 30, and the wirings 40.

The thickness of the protective layer 50 is 3 μm to 1,000 μm, and is preferably 5 μm to 200 μm, for example. The thickness of the protective layer 50 may not be uniform as long as it falls within the above range.

The elastic modulus of the protective layer 50 is, for example, equal to or less than 10 GPa. With a lower elastic modulus, it is possible to further absorb impact at the time of peeling and to curb damage on the protective layer 50.

The visible light internal transmittance of the protective layer 50 is equal to or greater than 50%, is preferably equal to or greater than 70%, and is more preferably equal to or greater than 90%, for example.

Note That the Protective Layer 50 Is Not Essential.

Examples of the transparent resin constituting the protective layer 50 include vinyl-based resins such as polyethylene (PE), polyvinyl chloride (PVC), polystyrene (PS), polyvinyl acetate (PVAc), polyvinyl alcohol (PVA), and polyvinyl butyral (PVB), olefin-based resins such as a cycloolefin polymer (COP) and a cycloolefin copolymer (COC), urethane-based resins such as thermoplastic polyurethane (TPU), polyester-based resins such as polyethylene terephthalate (PET) and polyethylene naphthalate (PEN), acrylic-based resins such as polymethyl methacrylate (PMMA), ethylene-vinyl acetate copolymer resins (EVA), and thermoplastic resins of copolymers thereof.

As the transparent resin constituting the protective layer 50, a transparent resin adhesive constituting the adhesive layer 12 can also be used.

Note that the protective layer 50 may be constituted by one type of transparent resin or may be constituted by a plurality of types of transparent resins.

### <Method of Manufacturing Display Device>

Next, an example of a method of manufacturing the display device according to the first embodiment will be described with reference to FIGS. 6 and 7 to 14. FIGS. 7 to 14 are sectional views illustrating an example of the method of manufacturing the display device according to the first embodiment. FIGS. 7 to 14 are sectional views corresponding to FIG. 6 and illustrate a state where the display region 101 is formed on the transparent substrate 10.

First, as illustrated in FIG. 7, the first metal layer M1 is formed on substantially the entire surface of the main substrate 11, and the first metal layer M1 is then patterned by photolithography to thereby form a lower layer wiring. Specifically, the lower layer wirings are formed by the first metal layer M1 at the positions where the power supply line 41, the ground line 42, the row data line 43, the column data line 44, and the like illustrated in FIG. 5 are to be formed.

Note that lower layer wirings are not formed at intersections of the power supply line 41, the ground line 42, and the column data line 44 with the row data line 43.

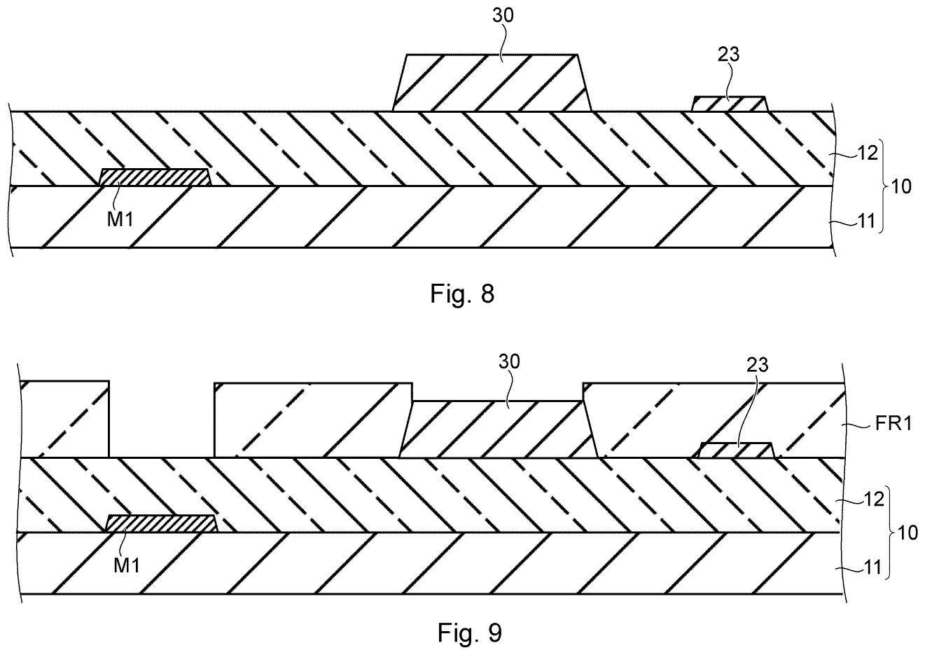

Next, as illustrated in FIG. 8, the adhesive layer 12 is formed on substantially the entire surface of the main substrate 11, and the LED elements 21 to 23 and the IC chip 30 are then mounted on the adhesive layer 12 having tackiness (that is, on the transparent substrate 10).

Here, the LED elements 21 to 23 are obtained by growing crystals on a wafer using, for example, a liquid phase growth method, a hydride vapor phase epitaxy (HVPE) method, a metal organic chemical vapor deposition (MOCVD) method, or the like, and then patterning the crystals. The LED elements 21 to 23 patterned on the wafer are transferred onto the transparent substrate 10 using, for example, a micro-transfer printing technique. For the IC chip 30, the IC chip 30 patterned on an Si wafer, for example, is transferred onto the transparent substrate 10 using the micro-transfer printing technique similarly to the LED elements 21 to 23.

Next, as illustrated in FIG. 9, a photoresist FR1 is formed on substantially the entire surface of the transparent substrate 10 including the main substrate 11 and the adhesive layer 12, and the photoresist FR1 on the first metal layer M1 is then removed by patterning. Here, the photoresist FR1 at the intersections of the row data line 43 with the power supply line 41, the ground line 42, and the column data line 44 illustrated in FIG. 5 is not removed.

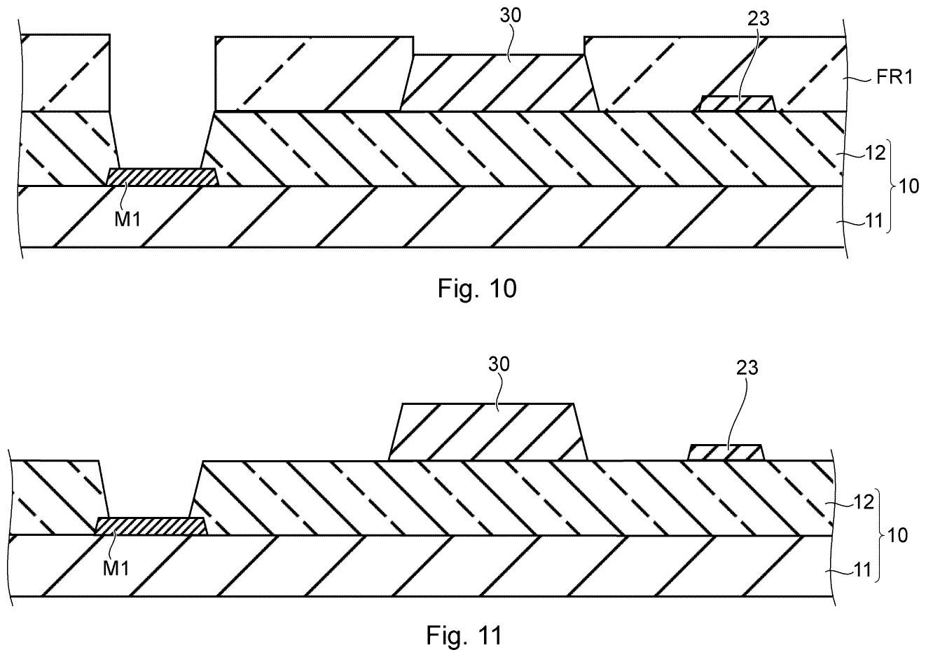

Next, as illustrated in FIG. 10, the adhesive layer 12 at the place from which the photoresist FR1 has been removed is removed by dry etching to expose the first metal layer M1, that is, the lower layer wirings.

Next, as illustrated in FIG. 11, the photoresist FR1 on the transparent substrate 10 is entirely removed. Thereafter, a plating seed layer, which is not illustrated, is formed on substantially the entire surface of the transparent substrate 10.

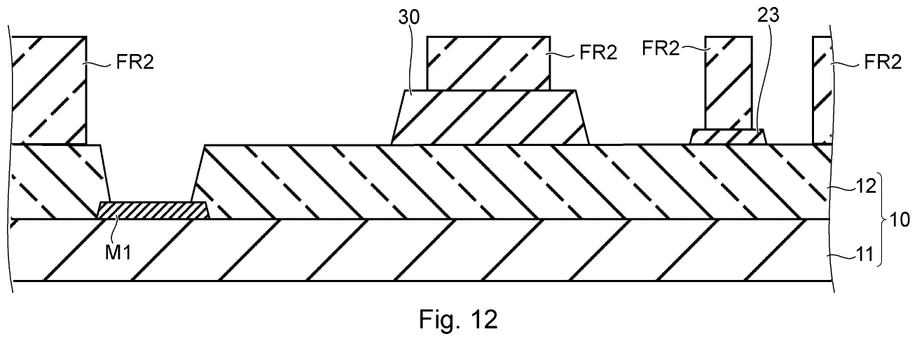

Next, as illustrated in FIG. 12, a photoresist FR2 is formed on substantially the entire surface of the transparent substrate 10, and the photoresist FR2 at the place where upper layer wirings are to be formed is then removed by patterning to thereby expose the seed layer.

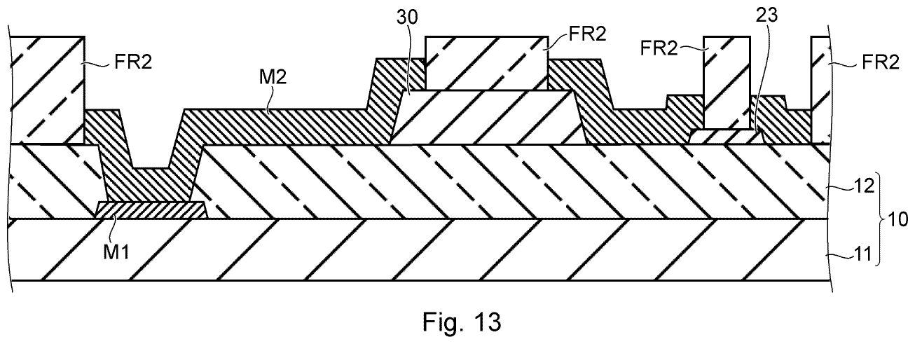

Next, as illustrated in FIG. 13, the second metal layer M2 is formed by plating at the place from which the photoresist FR2 has been removed, that is, on the seed layer. In this manner, the upper layer wirings are formed by the second metal layer M2.

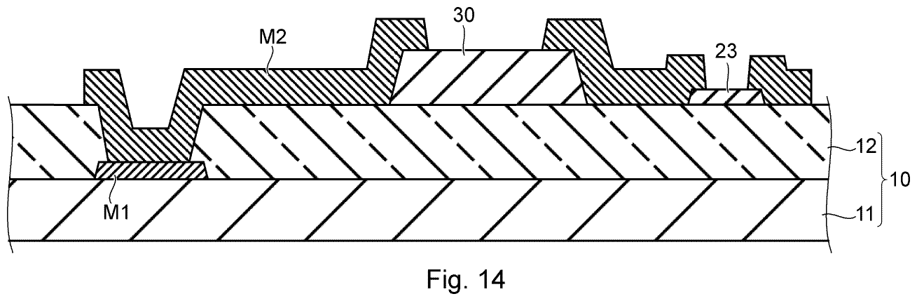

Next, as illustrated in FIG. 14, the photoresist FR2 is removed. Furthermore, the seed layer exposed by the removal of the photoresist FR2 is removed by etching.

As described above, the display region 101 is formed on the transparent substrate 10.

### Second Embodiment

Next, a laminated transparent plate according to a second embodiment will be described with reference to FIG. 15. FIG. 15 is a schematic plan view illustrating an example of the laminated transparent plate according to the second embodiment. FIG. 15 is a diagram corresponding to FIG. 1 of the first embodiment.

In the laminated transparent plate 400 according to the first embodiment illustrated in FIG. 1, the near-field wireless communication antenna 200 is disposed to overlap the display device 100 in plan view.

On the other hand, in the laminated transparent plate 400 according to the present embodiment illustrated in FIG. 15, a display device 100 and a near-field wireless communication antenna 200 are disposed to be aligned at a predetermined interval d in plan view. Therefore, the electromagnetic shield member 300 illustrated in FIG. 1 is not needed in FIG. 15.

Specifically, in the laminated transparent plate 400 according to the present embodiment illustrated in FIG. 15, the near-field wireless communication antenna 200 is disposed with a deviation of the interval d from the display device 100 along outer edge portions of transparent plates 420a and 420b.

With such a configuration, the laminated transparent plate 400 according to the present embodiment can reduce noise generated in an image displayed by the display device 100 due to the near-field wireless communication antenna 200 without providing the electromagnetic shield member 300.

Here, the interval d between the display device 100 and the near-field wireless communication antenna 200 illustrated in FIG. 15 is equal to or greater than 5 mm. The interval d is preferably equal to or greater than 10 mm, and is further preferably equal to or greater than 15 mm. More specifically, the interval d is the shortest distance between wirings 40 of the display device 100 and a coil 220 of the near-field wireless communication antenna 200.

With a larger interval d, it is possible to further reduce noise generated in an image displayed by the display device 100 due to the near-field wireless communication antenna 200. On the other hand, if the interval d, that is, the interval between the position of the near-field wireless communication antenna 200 over which a user is to place an IC card and the position of the display device 100 where predetermined information is displayed is excessively large, convenience of the user is degraded.

Similarly to the display device 100 illustrated in FIG. 1, the display device 100 illustrated in FIG. 15 is also provided at an end portion of the laminated transparent plate 400, and a flexible wiring board 60 extends from the transparent plates 420a and 420b. The flexible wiring board 60 is connected to a display device drive circuit 70 for driving display device 100. In other words, the display device drive circuit 70 is provided outside the transparent plates 420a and 420b.

Note that an antenna drive circuit 230 for driving the near-field wireless communication antenna 200 is provided outside the transparent plates 420a and 420b as illustrated in FIG. 15. Therefore, a wiring for driving the coil 220, that is, the near-field wireless communication antenna 200 extends from the transparent plates 420a and 420b.

As described above, the display device 100 and the near-field wireless communication antenna 200 are disposed to be aligned at the predetermined interval d (d≥5 mm) in plan view in the laminated transparent plate 400 according to the present embodiment. Therefore, the laminated transparent plate 400 according to the present embodiment can reduce noise generated in an image displayed by the display device 100 due to the near-field wireless communication antenna 200 without providing the electromagnetic shield member 300. Since the other configurations are similar to those in the laminated transparent plate according to the first embodiment, detailed description thereof will be omitted.

### Third Embodiment

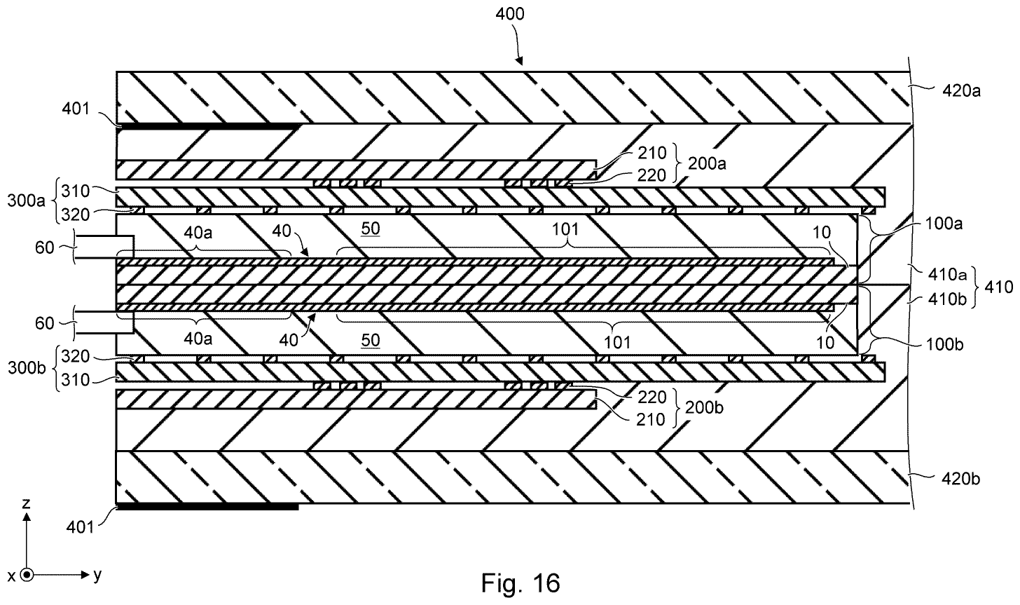

Next, a laminated transparent plate according to a third embodiment will be described with reference to FIG. 16. FIG. 16 is a schematic sectional view illustrating an example of the laminated transparent plate according to the third embodiment. FIG. 16 is a diagram corresponding to FIG. 4 of the first embodiment.

The display device 100, the near-field wireless communication antenna 200, and the electromagnetic shield member 300 are sandwiched between the pair of transparent plates 420a and 420b via the intermediate films 410a and 410b in the laminated transparent plate 400 according to the first embodiment illustrated in FIG. 4.

On the other hand, display devices 100a and 100b, near-field wireless communication antennas 200a and 200b, and electromagnetic shield members 300a and 300b are sandwiched between a pair of transparent plates 420a and 420b via intermediate films 410a and 410b in a laminated transparent plate 400 according to the present embodiment illustrated in FIG. 16.

In other words, the laminated transparent plate 400 according to the first embodiment illustrated in FIG. 4 includes one set of the display device, the near-field wireless communication antenna, and the electromagnetic shield member, while the laminated transparent plate 400 according to the present embodiment illustrated in FIG. 16 includes two sets of display devices, near-field wireless communication antennas, and electromagnetic shield members.

Note that planar arrangement of the display device 100a, the near-field wireless communication antenna 200a, and the electromagnetic shield member 300a is similar to the planar arrangement of the display device 100, the near-field wireless communication antenna 200, and the electromagnetic shield member 300 illustrated in FIG. 1. Note that planar arrangement of the display device 100b, the near-field wireless communication antenna 200b, and the electromagnetic shield member 300b is similar to the planar arrangement of the display device 100, the near-field wireless communication antenna 200, and the electromagnetic shield member 300 illustrated in FIG. 1.

According to the laminated transparent plate 400 of the first embodiment illustrated in FIG. 4, the user performs wireless communication with the near-field wireless communication antenna 200 via the transparent plate 420a using an IC card while visually recognizing an image displayed on the display device 100 from the outside of the vehicle via the transparent plate 420a.

On the other hand, according to the laminated transparent plate 400 of the present embodiment illustrated in FIG. 16, a user performs wireless communication with the near-field wireless communication antenna 200a via the transparent plate 420a using an IC card while visually recognizing an image displayed on the display device 100a from the outside of the vehicle via the transparent plate 420a. Here, the near-field wireless communication antenna 200a is provided between the transparent plate 420a and the display device 100a as illustrated in FIG. 16. Furthermore, the electromagnetic shield member 300a is provided between the display device 100a and the near-field wireless communication antenna 200a.

Furthermore, according to the laminated transparent plate 400 of the present embodiment illustrated in FIG. 16, the user performs wireless communication with the near-field wireless communication antenna 200b via the transparent plate 420b using an IC card while visually recognizing an image displayed on the display device 100b from the inside of the vehicle via the transparent plate 420b. Here, the near-field wireless communication antenna 200b is provided between the transparent plate 420b and the display device 100b as illustrated in FIG. 16. Furthermore, the electromagnetic shield member 300b is provided between the display device 100b and the near-field wireless communication antenna 200b.

Note that although the transparent substrates 10 of the display devices 100a and 100b are attached to each other in the laminated transparent plate 400 illustrated in FIG. 16, the display devices 100a and 100b may share a transparent substrate. In other words, wirings 40 and the like are formed on both surfaces of one transparent substrate 10, and the display device 100a visually recognized via the transparent plate 420a and the display device 100b visually recognized via the transparent plate 420b may be integrally formed.

As illustrated in FIG. 16, the electromagnetic shield member 300a is provided between the display device 100a and the near-field wireless communication antenna 200a disposed to overlap each other in plan view in the laminated transparent plate 400 according to the present embodiment. With such a configuration, it is possible to reduce noise generated in an image displayed by the display device 100a due to the near-field wireless communication antenna 200a. It is a matter of course that with such a configuration, it is possible to reduce noise generated in an image displayed by the display device 100b due to the near-field wireless communication antenna 200a.

On the other hand, the electromagnetic shield member 300b is provided between the display device 100b and the near-field wireless communication antenna 200b disposed to overlap each other in plan view in the laminated transparent plate 400 according to the present embodiment as illustrated in FIG. 16. With such a configuration, it is possible to reduce noise generated in an image displayed by the display device 100b due to the near-field wireless communication antenna 200b. It is a matter of course that noise generated in an image displayed by the display device 100a due to the near-field wireless communication antenna 200b can also be reduced with such a configuration.

Furthermore, the near-field wireless communication antenna 200a and the near-field wireless communication antenna 200b are disposed via the two electromagnetic shield members 300a and 300b as illustrated in FIG. 16. With such a configuration, it is possible to effectively curb a mutual interference between a wireless signal of the near-field wireless communication antenna 200a and a wireless signal of the near-field wireless communication antenna 200b.

Since the other configurations are similar to those in the laminated transparent plate according to the first embodiment, detailed description thereof will be omitted.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A laminated transparent plate comprising:
a pair of transparent plates;
a display device that is sandwiched between the pair of transparent plates and includes a first substrate and a plurality of display elements formed on the first substrate; and
a near-field wireless communication antenna that is sandwiched between the pair of transparent plates and includes a second substrate and a spiral coil formed on the second substrate, wherein
the display device and the near-field wireless communication antenna are disposed to overlap each other in plan view, and
an electromagnetic shield member that includes a third substrate and a metal mesh film formed on the third substrate is provided between the display device and the near-field wireless communication antenna.

2. The laminated transparent plate according to claim 1, wherein
a line pitch of the metal mesh film is 100 μm to 6,000 μm, and
a line width of the metal mesh film is 3 μm to 200 μm.

3. The laminated transparent plate according to claim 1, wherein
each of the first to third substrates is transparent,
the plurality of display elements are light emitting diode elements that are each arranged for each pixel and have an area of equal to or less than 10,000 μm², and
the display device is a transparent display device.

4. The laminated transparent plate according to claim 1, wherein the metal mesh film is constituted by metal containing any of Cu, Ni, Fe, and Cr as a main component.

5. The laminated transparent plate according to claim 1, further
a first drive circuit that drives the display device; and
a second drive circuit that drives the near-field wireless communication antenna, wherein
the first and second drive circuits are both provided outside the pair of transparent plates.

6. The laminated transparent plate according to claim 5, wherein wirings extending from the pair of transparent plates are electromagnetically shielded in order to connect the near-field wireless communication antenna to the second drive circuit.

7. The laminated transparent plate according to claim 1, wherein the pair of transparent plates is a pair of glass plates.

8. The laminated transparent plate according to claim 7, further comprising:
a first intermediate film that is provided between one of the pair of glass plates and the display device; and
a second intermediate film that is provided between the other one of the pair of glass plates and the near-field wireless communication antenna.

9. The laminated transparent plate according to claim 1, wherein
the laminated transparent plate is used for a window of a self-driving vehicle,
the display device displays a fare of the self-driving vehicle, and
a user of the self-driving vehicle pays the fare through communication using the near-field wireless communication antenna.

10. A laminated transparent plate comprising:
a pair of transparent plates;
a display device that is sandwiched between the pair of transparent plates and includes a first substrate and a plurality of light emitting elements formed on the first substrate; and
a near-field wireless communication antenna that is sandwiched between the pair of transparent plates and includes a second substrate and a spiral coil formed on the second substrate, wherein
the display device and the near-field wireless communication antenna are disposed to be aligned in plan view, and
an interval between the display device and the near-field wireless communication antenna is equal to or greater than 5 mm.

11. A method of manufacturing a laminated transparent plate in which a display device that includes a first substrate and a plurality of light emitting elements formed on the first substrate and a near-field wireless communication antenna that includes a second substrate and a spiral coil formed on the second substrate are sandwiched between a pair of transparent plates, the method comprising:
disposing the display device and the near-field wireless communication antenna to overlap each other in plan view; and
providing an electromagnetic shield member that includes a third substrate and a metal mesh film formed on the third substrate between the display device and the near-field wireless communication antenna.

12. A method of manufacturing a laminated transparent plate in which a display device that includes a first substrate and a plurality of light emitting elements formed on the first substrate and a near-field wireless communication antenna that includes a second substrate and a spiral coil formed on the second substrate are sandwiched between a pair of transparent plates, the method comprising:
disposing the display device and the near-field wireless communication antenna in an aligned manner in plan view; and
setting an interval between the display device and the near-field wireless communication antenna to be equal to or greater than 5 mm.
